(19) United States
(12) Patent Application Publication
(10) Pub. No.: US 2008/0209881 A1
(43) Pub. Date: Sep. 4, 2008

(54) BAUER BLADE

(76) Inventor: Steve Craig Bauer, Kurtistown, HI (US)

Correspondence Address: CRAIG A. SIMMERMON, 251 LYMAN CIR., SACRAMENTO, CA, 95835, US

(21) Appl. No.: 12/053,737

(22) Filed: Mar. 24, 2008

Related U.S. Application Data
(63) Continuation of application No. 11/308,932, filed on May 26, 2006.

(51) Int. Cl. A01D 34/416

(52) U.S. Cl. 56/12.7

(57) ABSTRACT

The Bauer Blade is used to cut vegetation and can be used as a replacement blade for a conventional lawnmower blade. It is a one-piece molded, casted, machined, or stamped disc with blade shaft hole(s) and flexible cutting material. The invention is a safer and more efficient blade to operate than traditional lawnmower blades. The invention also includes a specially designed lawnmower that, when used in conjunction with the Bauer Blade, provides the capability to mow and edge trim a lawn in one operation.

### CROSS-REFERENCE TO RELATED APPLICATIONS

The instant application is a continuation of U.S. application Ser. No. 11/308,932 entitled “The Bauer Blade” filed on May 26, 2006 and claims the benefit of such application.

### BACKGROUND OF INVENTION

Conventional metal lawnmower blades are prone to problems related to human injury, property damage, lawnmower maintenance, air pollution, fuel economy, and the inherent requirement for second-operation edge trimming around sidewalks and trees and such.

The Bauer Blade uses a flexible cutting material as its “blade” that will not penetrate shoes or work gloves. Thus, the invention protects against direct blade injury.

The flexible blade material of the Bauer Blade is many times lighter than the blade material of a conventional lawnmower blade. This greatly reduces momentum transfer from the blade to objects in the lawn. Objects in the lawn include intended targets such as vegetation as well as unintended targets such as debris located in the lawn. When a conventional lawnmower blade strikes a debris object, the blade typically knocks the object into motion at a high rate of speed. This activity frequently results in projectiles shooting out from the lawnmower which can cause significant human injury and property damage. The Bauer Blade, conversely, does not initiate large enough momentum transfer to produce high-speed dangerous projectiles. Consequently, the Bauer Blade significantly reduces the production of dangerous projectiles and the injuries resulting therefrom. These two safety factors alone, protection from direct blade injury and from indirect blade or projectile injury, provide very significant advantages over conventional lawnmower blades.

Maintenance is another advantage. Conventional lawnmower blades require sharpening, which typically requires removal of the blade from the lawnmower, drop-off time at a sharpening service provider, and then reinstallation of the blade. Sharpening is necessitated by normal wear from cutting vegetation or by collision with foreign objects. The Bauer Blade never needs sharpening. Unlike conventional lawnmower blades, the Bauer Blade typically can be “renewed” in less than five minutes, without tools or downtime. Renewal is required annually or more typically biannually, depending on frequency of use, toughness of the vegetation, and toughness of the particular flexible cutting material used in the Bauer Blade. Renewal is the replacement of worn flexible cutting material with new flexible cutting material.

Conventional lawnmower blades cause damage to uneven ground, tree roots, garden hoses, sprinkler heads, and other valuable. The Bauer Blade will not damage these items because the flexible cutting material skims right over them without scalping.

Moreover, the shape of the Bauer Blade has advantages over the shape of conventional lawnmower blades. The Bauer Blade is essentially a large disc that does not readily transfer momentum to targets in the lawn and therefore does not incur large drag forces during rotation. This behavior is summed up by the application of Newton's third law to the particular dynamics at hand—large momentum transfer from conventional blade to targets yields large drag forces on the conventional blade, conversely, small momentum transfer from Bauer Blade to targets yields small drag forces on Bauer Blade. The Bauer Blade experiences drag primarily only from its lightweight flexible cutting material passing through the target area. A conventional blade, on the other hand, is essentially two heavy rigid spinning knives that incur drag forces across the full length of the structure.

Also, the cutting portions of conventional blades are extremely heavy as compared to the weight of the vegetation for which the blade is used to cut. This enormous weight difference is not required for successful cutting and is, in fact, detrimental to safety, property damage, maintenance, air pollution, and fuel economy of the mower because of the large degree of momentum transfer between the blade and its targets.

The net result is that conventional metal lawnmower blades require significantly more energy to keep in rotational motion. The Bauer Blade, on the other hand, uses much less energy to sustain rotation. Since current technology of battery powered lawnmowers is less than optimal for want of longer battery life, the Bauer Mower would likely improve technology in this area as its use would yield longer battery life.

### BRIEF DESCRIPTION OF THE DRAWINGS

FIG. 1 is a perspective view of the best mode.

FIG. 2 is a cross-sectional view of the best mode.

FIG. 3 is a bottom view of the Mushroom flexible cutting material attachment means.

FIG. 4 is a top view of the Bent flexible cutting material attachment means.

FIG. 5 is a bottom view of the Camlock flexible cutting material attachment means.

FIG. 6 is a top view of the Knot flexible cutting material attachment means.

FIG. 7 is a perspective view of the Bauer Mower which is defined by claims 5 and 6.

DEFINITION LIST

| Term | Definition |
|---|---|
| 10 | Bauer Blade |
| 20 | One-piece molded, casted, machined, or stamped disc |
| 30 | Flexible cutting material |
| 40 | Location of blade shaft holes |
| 50 | Location of flexible cutting material attachment means |
| 52 | Knot flexible cutting material attachment means |
| 54 | Mushroom flexible cutting material attachment means |
| 56 | Camlock flexible cutting material attachment means |
| 58 | Bent flexible cutting material attachment means |
| 60 | Overall Disc Radius |
| 70 | Knot |
| 80 | Mushroom |
| 90 | Camlock |
| 100 | Center line of blade shaft |
| 110 | Upper portion of the lawnmower blade cavity housing |
| 130 | Trimming Opening |
| 140 | Bauer Mower |

### DETAILED DESCRIPTION OF EMBODIMENTS

The invention 10 can serve as a replacement blade for a conventional lawnmower blade on a standard one-blade lawnmower or multi-blade mowers such as riding lawnmowers or wide-cutting walk behind mowers.

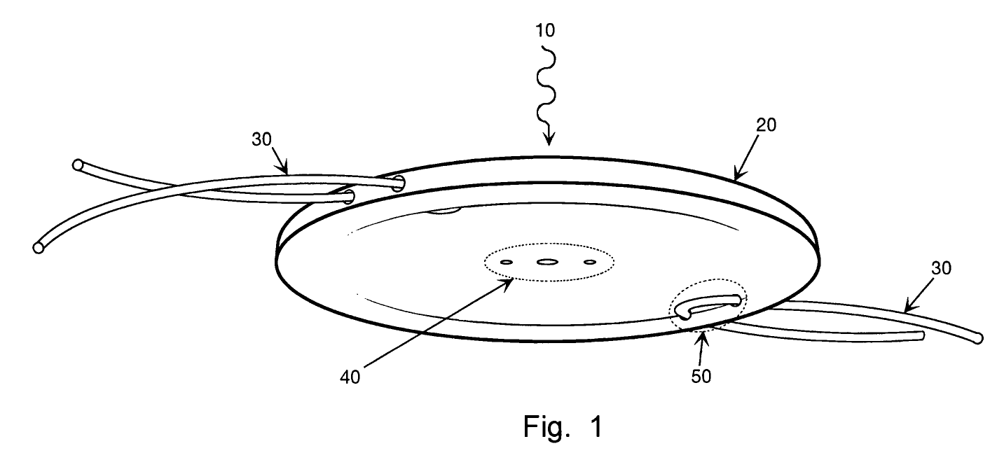

The preferred embodiment of the invention is depicted in FIG. 1. Most lawnmowers have a single blade shaft with threaded female end at which point a blade is reversibly secured thereto with a washer and bolt. In this instance, the Bauer Blade is attached to the blade shaft through the center blade shaft hole at 40 using a washer and bolt. Other lawnmowers have a blade shaft with two female thread locations, as with some currently manufactured Honda brand lawnmowers. In this instance, the Bauer Blade is attached to the blade shaft through the two blade shaft holes located on opposite sides of the center blade shaft hole at 40 using two washers and two bolts.

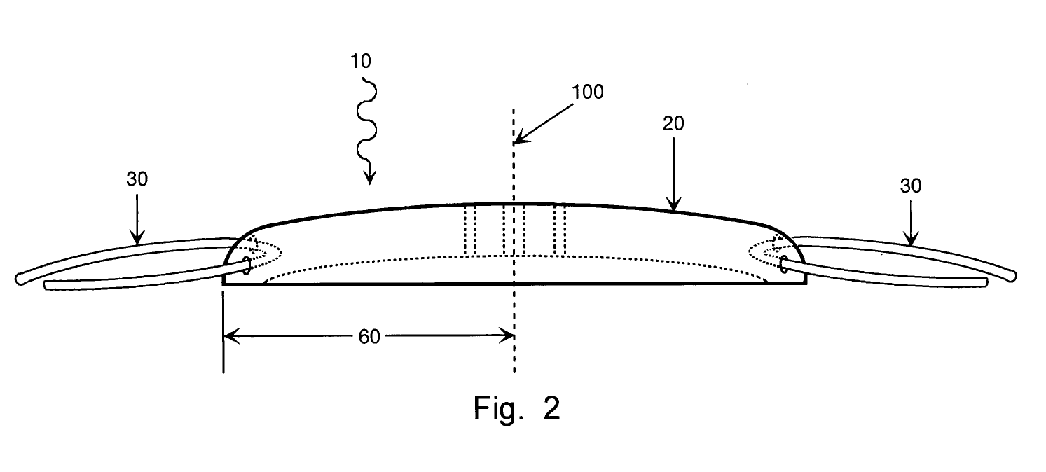

The preferred embodiment of the flexible cutting material attachment means is depicted in FIGS. 1, 2, and 4. This flexible cutting material attachment means is called the “Bent” flexible cutting material attachment means. The flexible cutting material 30 is simply bent into a V-shape and then inserted into the two flexible cutting material holes at 50. FIGS. 1 and 2 depict the invention with two flexible cutting materials 30 attached to the one-piece molded, casted, machined, or stamped disc 20 and is the preferred embodiment. There are two holes in the one-piece molded, casted, machined, or stamped disc 20 at each flexible cutting material attachment location 50 with the Bent flexible cutting material attachment means. Therefore, the preferred embodiment as depicted in FIGS. 1 and 2 contains four flexible cutting material holes and two attached flexible cutting materials 30.

Another flexible cutting material attachment means is depicted in FIG. 5. The “Camlock” flexible cutting material attachment means includes a ratchet mechanism or camlock 90 that allows the flexible cutting material 30 to be inserted from the outer direction of the one-piece molded, casted, machined, or stamped disc 20 and slid into a camlock 90. The camlock 90 then grabs the flexible cutting material 30 and prevents it from moving outwardly from the one-piece molded, casted, machined, or stamped disc 20. Note that the camlock 90 depicted in FIG. 5, as denoted by solid lines, is technically incorrect as the camlock is actually situated in a recessed area located in the inner portion of the one-piece molded, casted, machined, or stamped disc 20. Therefore the camlock 90 should be depicted with dashed lines. The depiction of camlock 90 with solid lines was done to show more detail of the camlock, especially its teeth, which create the ratcheting action for the flexible cutting material 30. With this flexible cutting material attachment means, the flexible cutting material 30 is removed by further pushing the flexible cutting material 30 inward until it has cleared the camlock 90. This flexible cutting material attachment means has application with heavier and less flexible cutting material.

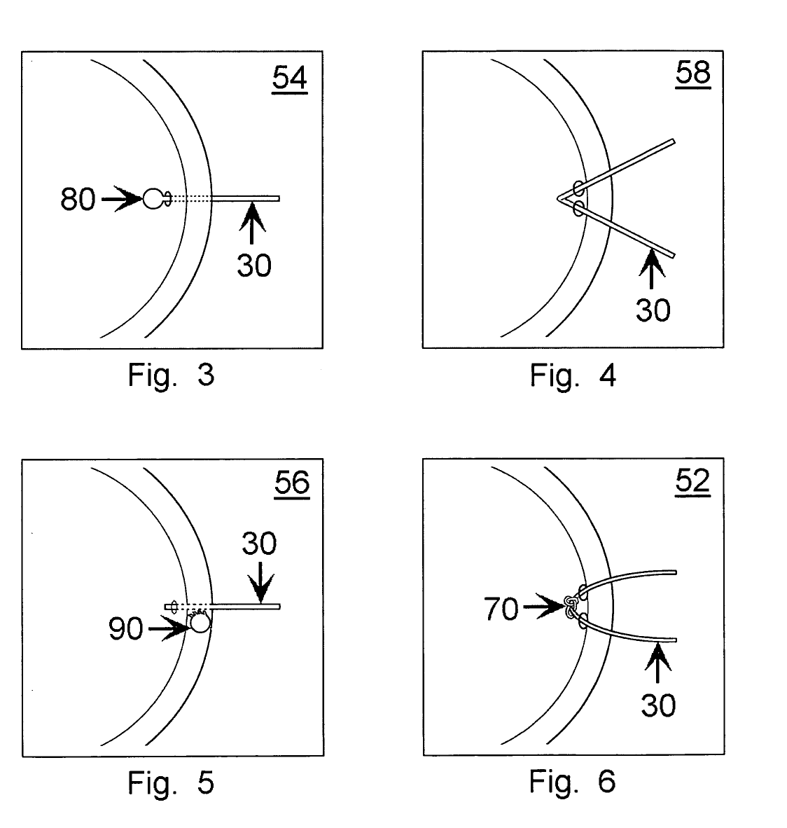

Another flexible cutting material attachment means is depicted in FIG. 3. The “Mushroom” flexible cutting material attachment means uses one hole per flexible cutting material attachment means where the flexible cutting material 30 is slid into the one-piece molded, casted, machined, or stamped disc 20 from the inward side of the one-piece molded, casted, machined, or stamped disc 20. The flexible cutting material 30 is held in place by centrifugal force on the bulbous portion or mushroom 80 of the flexible cutting material 30. The flexible cutting material 30 is supplied with the mushroom 80 already formed on the flexible cutting material 30.

Another flexible cutting material attachment means is depicted in FIG. 6. This is the “Knot” flexible cutting material attachment means. In this instance the flexible cutting material 30 is bent into a U-shape and knotted at 70 at the base of the U. Each leg of the U is then fed into a flexible cutting material hole from the inward direction of the one-piece molded, casted, machined, or stamped disc 20. This flexible cutting material attachment means is similar to the preferred embodiment, the Bent flexible cutting material attachment means, but in this case, the flexible cutting material 30 is knotted at 70 to provide additional assurance that the flexible cutting material 30 will not slide out off of the one-piece molded, casted, machined, or stamped disc 20. This flexible cutting material attachment means may have application with more flexible smaller diameter flexible cutting material 30.

FIGS. 3-6 all depict one flexible cutting material 30 per one-piece molded, casted, machined, or stamped disc 20. However the preferred embodiment is to have two flexible cutting materials 30 per one-piece molded, casted, machined, or stamped disc 20.

The one-piece molded, casted, machined, or stamped disc 20 needs to be balanced to insure proper rotation at the typical rotations-per-minute of lawnmower motors without wobbling or unsteady rotation. Balancing may also require the one-piece molded, casted, machined, or stamped disc 20 to have similar overall weight to that of the conventional metal blade for which the invention is to replace. This requirement could translate into sizing requirements for the Bauer Blade. One-piece molded, casted, machined, or stamped discs 20 should have an Overall Disc Radius 60 of 40-60% of the “internal blade cavity radius” measurement. The “internal blade cavity radius” measurement is specific to a particular lawnmower model and is defined as distance between the center-line of the blade shaft 100 to the inside diameter of the mower housing or, in the case of multi-blade mowers, the distance between the center-line of blade shaft 100 to the outer diameter of the next closest adjacent blade. An overall disc radius 60 of essentially one half the internal blade cavity radius measurements is the preferred embodiment. Thus, with the preferred embodiment, the flexible cutting material 30 length would also equal essentially half of the internal blade cavity radius measurement. With the preferred embodiment, the distance between the center-line of the blade shaft 100 and inside diameter of the mower housing should essentially be divided into two equal sections: half disc and half flexible cutting material. The same proportions should be used when fitting multi-blade mowers with the preferred embodiment of the Bauer Blade, i.e. the distance between the blade shaft center-line 100 and the outer diameter of the next closest adjacent blade should essentially be half disc and half flexible cutting material.

When renewing the flexible cutting material 30, one need only add new flexible cutting material 30 with excess length and the Bauer Blade will self-correct the length of flexible cutting material 30 by wearing away excess flexible cutting material 30 against the mower housing. This technique should also be applied when renewing flexible cutting material on multi-blade lawnmowers. In this case, the length of flexible cutting material 30 self-corrects against the flexible cutting material 30 on the next closest adjacent Bauer Blade and vice versa.

Despite that only round cross-sectional flexible cutting material 30 is depicted in the drawings, the flexible cutting material 30 of the Bauer Blade may be of a non-round cross-sectional geometric shape to provide more efficient vegetation cutting. The preferred embodiment of the invention is a round cross-sectional shape because round cutting line is readily available and is extremely cost effective.

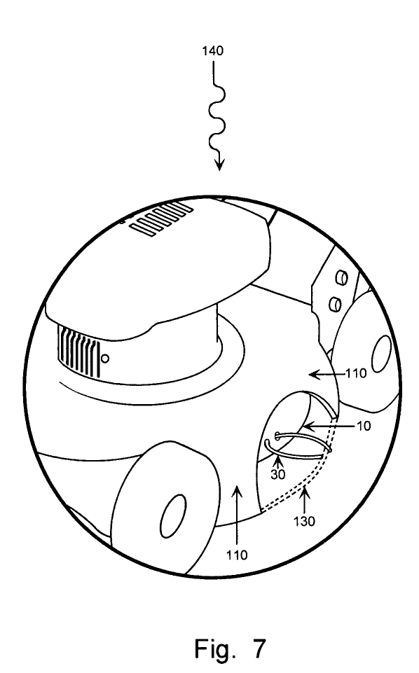

As depicted in FIG. 7, when the Bauer Blade 10 is installed into a specially designed lawnmower, the Bauer Mower 140, an operator can mow a lawn and edge trim the lawn in the same operation. In this regard, the Bauer Mower 140 is the complement to the Bauer Blade 10.

As with most conventional lawn mowers, the Bauer Mower 140 has a lawnmower blade cavity housing which protects people from flying debris kicked up by the lawn mower blade. Typically, a lawnmower blade cavity housing has but two openings: i) one at the bottom of the housing, through which the blade may have access to vegetation to cut and ii) another on the side of the housing, through which to expel cut vegetation from the blade cavity housing. The Bauer Mower 140 has these two openings in the lawnmower blade cavity housing. Additionally, the Bauer Mower 140 has a third opening in the lawnmower blade cavity housing, defined as the trimming opening 130. The trimming opening 130 is located on the upper portion of the lawnmower blade cavity housing 110. FIG. 4 depicts the trimming opening 130 as the upper portion of the lawnmower blade cavity housing 110 that “was removed” in order to “create” the trimming opening 130. This method of depiction was used as an attempt to increase clarity of definition of the Bauer Mower 140. Although this method of manufacture, i.e. creating the trimming opening 130 by removal of material from a standard blade cavity housing may have application to the production of Bauer Mowers 140 with the open and close mechanism described in claim 6, as the removed piece could then be used as the shield to close the trimming hole 130, the Bauer Mower 140 is not limited to manufacture by this method.

The trimming opening 130 exposes the Bauer Blade 10 and, more specifically, the flexible cutting material 30 to area outside of the lawnmower blade cavity housing. This “flexible cutting material exposed” area or trimming opening 130 may be used to trim around trees, curbing, sidewalks, driveways, and other items. The trimming opening 130 could be maneuvered carefully, in a manner similar to the movement of a conventional weed-whacker string edge trimmer, around these items, yielding a mowed and trimmed lawn without second operation.

As discussed, the Bauer Blade 10 has lower drag forces than those associated with conventional lawnmower blades. Consequently, a Bauer Mower 140, equipped with a Bauer Blade 10, requires less energy to operate. Given the current technology of battery powered lawnmowers, the Bauer Mower 140 may likely be much better suited for clean electric/battery power than standard lawnmowers with conventional metal blades.

Although FIG. 7 does not depict an open and close mechanism which would open and close the trimming opening 130, a mode of the Bauer Mower 140 does include such a mechanism. With this mode, the trimming opening 130 would only be opened for trimming and would be closed thereafter by the mower operator. This open and close mechanism is added for safety purposes and is the preferred embodiment of the Bauer Mower 140.

What is claimed is:

1. Apparatus used for cutting, comprising:
a one-piece molded, casted, machined, or stamped disc with one blade shaft hole in the center;
one or more flexible cutting materials; and
a flexible cutting material attachment means to attach said one or more flexible cutting materials to said one-piece molded, casted, machined, or stamped disc.

2. Apparatus as in claim 1 wherein said one or more flexible cutting materials is made of plastic with cross-sectional geometrical shape having outer diameter ranging from 0.050″ to 0.200″.

3. Apparatus as in claim 1 further comprising two additional blade shaft holes in the center of said one-piece molded, casted, machined, or stamped disc.

4. Apparatus as in claim 3 wherein said one or more flexible cutting materials is made of plastic with cross-sectional geometrical shape having outer diameter ranging from 0.050″ to 0.200″.

5. A lawnmower with a trimming opening 130 in the upper portion of the lawnmower blade cavity housing 110 wherein the lawnmower blade in said lawnmower is an apparatus according to any of the preceding claims.

6. A lawnmower according to claim 5, wherein said lawnmower further comprises an open and close mechanism wherein said open and close mechanism closes said trimming opening 130 and opens said trimming opening 130 and is done so under the control of the operator of said lawnmower.
